(19) United States
(12) Patent Application Publication
(10) Pub. No.: US 2011/0128278 A1
(43) Pub. Date: Jun. 2, 2011

(54) REGULATING CIRCUIT

(76) Inventors: Patrick Schalberger, Stuttgart (DE); Marcus Herrmann, Neuffen (DE); Norbert Fruehauf, Sindelfingen (DE)

(21) Appl. No.: 12/953,789

(22) Filed: Nov. 24, 2010

(30) Foreign Application Priority Data
Dec. 1, 2009 (DE) 10 2009 056 319.9

(51) Int. Cl. G09G 5/10

(52) U.S. Cl. 345/212

(57) ABSTRACT

A regulating circuit for driving a display screen pixel having a light-emitting diode includes at least one operational amplifier (11) having a first input (12), a second input (13), and an output (16). A measuring signal (Uₘₑₛₛ) dependent on the flow of current through a driver transistor of the light-emitting diode is applicable to the first input (12) and a network (15, 15′) consisting of active and/or passive components and at least one capacitor (C) is connected to the second input (13). The network (15, 15′) has a plurality of inputs (U₁-Uₙ). A digital reference input signal is applicable to the plurality of inputs (U₁-Uₙ), and the output (16) of the operational amplifier (11) is connected to a data line of the pixel.

### BACKGROUND OF THE INVENTION

High-resolution display screens with light-emitting diodes, in particular with organic light-emitting diodes (OLEDs), as a rule need active control of the LEDs which requires at least two transistors for each pixel. One of these transistors operates as a switch for the data voltage, and a second transistor, as a current driver for the light-emitting diode (LED). The current flowing through the light-emitting diode corresponds to the drain current of the current-driving transistor, the drain current being a function of the gate voltage of this transistor.

The transistors are usually realized as thin-film transistors whose parameters are subject to great variation incurred in their manufacture. In particular, the threshold voltage and the charge carrier mobility of the transistors exhibit great inconsistencies. The concomitant spatial fluctuations in the LED driver currents result in disturbing spatial inconsistencies in the brightness of the display screen.

To remedy this problem, DE 10254511 B4 has proposed that the diode driver current be fed to a current-measuring and voltage-regulating circuit which passes a voltage signal dependent on the current measurement result to the data line of the pixel and thus regulates the current flowing through the LED to a desired value. However, no circuit embodying this regulation is specified.

A feedback circuit for an active matrix display with an operational amplifier is known from CA 2443206 A1. An analogue voltage signal is applied to one of the inputs of this operational amplifier, but how this voltage signal is generated is not specified. Furthermore, the known circuit has a tendency to overshoot.

A current feedback circuit is described in the article “A Driving Scheme for Active-Matrix Organic Light-Emitting Diode Displays Based on Current Feedback” by Ashtiani and Nathan (Journal of Display Technology, Vol. 5, No. 7, pp. 257-264, 2009) but needs analogue currents as data signals for the compensation circuit, which requires complex and expensive circuitry.

### SUMMARY OF THE INVENTION

The fundamental problem of the present invention is to provide a regulating circuit for driving a pixel with an LED that can be realized with circuitry of low complexity and low cost but has high reliability.

The problem is solved with a regulating circuit for driving a display screen pixel having an LED with at least one operational amplifier to the first input of which a measuring signal dependent on the flow of current through the driver transistor of the LED is applicable and to the second input of which a network consisting of active and/or passive components and at least one capacitor is connected, the network having a plurality of inputs to which a digital reference input signal is applicable, and the output of the operational amplifier being connected to the data line of the pixel.

The distinctive feature of the regulating circuit according to the invention is that not only does it feed back the current through the driver transistor of the LED as a measuring signal to allow regulation of the data voltage, but it is moreover capable of receiving a digital data word as a reference input value and of making the necessary digital-analogue conversion. The complexity and cost of the circuitry is very low in comparison with known solutions. The capacitor connected to the second input prevents the operational amplifier from functioning merely as a comparator that is on full output when only small differential voltages are present on the input side. Because of the inertia of the control system generated by desired and parasitic capacitances, such behavior of the operational amplifier would lead to severe overshooting on the output side. The regulating circuit could even become unstable as a result. The capacitor provided in accordance with the invention, on the other hand, ensures that a steady state can be reliably reached at the output of the operational amplifier within the time available for the entry of a line into the display screen. The capacitor endows the regulating circuit with a primarily integrating characteristic, thus bringing about an at least significant reduction in overshooting. It is advantageous to arrange the capacitor between the second input and the output of the operational amplifier. It is of course also possible to provide several capacitors to further reduce the problem of overshooting.

Further advantages accrue if a digital voltage signal which is binary-weighted by the network is applicable to the inputs of the network. Encoding the digital reference input value in binary code makes the regulating circuit particularly robust. The network for the digital-analogue conversion can have a relatively simple construction.

In a preferred configuration of the regulating circuit, the measuring signal can be generated by a current-voltage conversion from a current signal of a driver transistor of the light-emitting diode. As a result of this conversion of the current through the LED into a voltage signal, the circuit can be kept relatively simple in its construction. A resistor, for example, may be used for the current-voltage conversion.

The network connected to the second input of the operational amplifier may have various configurations of passive and/or active components. In a preferred embodiment of the circuit, the network comprises resistors, and may even be formed entirely of resistors. However, it is also possible to provide switched capacitors in the network. The current-voltage converter may also be realized as a switched capacitor. The substitution of switched capacitors for resistors enables the sometimes high resistance values that are necessary to be realized in a way that is simpler, and more favorable in terms of area. The instabilities which occur when switched capacitors are substituted for resistors in integrator circuits do not constitute a problem in the regulating circuit according to the invention, as in the regulating circuit these instabilities are compensated via the pixel circuit.

In a particularly advantageous configuration of the circuit, the circuit may comprise thin-film transistors based on a polycrystalline semiconductor, e.g. silicon. It can be produced by the same technology as the actual pixel circuit. This facilitates in particular the integration of the circuit together with the pixels of the display screen on the same substrate. However, it is of course also possible to construct the circuit as a separate integrated circuit and to bond it to the display screen.

For the realization of this circuit with thin-film transistors, thin-film transistors with large dimensions may preferably be used for the operational amplifier and in particular for the input stage of the operational amplifier. Parameter variations between the thin-film transistors of the operational amplifier can be better reduced by averaging over a large number of crystalline semiconductor grains than would be the case with small-area transistors with only a small number of semiconductor grains.

Further advantages can be gained by integrating the circuit with other circuit elements needed for a column driver of an LED display screen, such as column selection registers and a data bus, on a common semiconductor chip or substrate. This will enable a marked reduction to be made in the number of external components and lead-ins of the display screen.

### BRIEF DESCRIPTION OF THE DRAWINGS

FIG. 1 is a circuit diagram of a first embodiment of a regulating circuit according to the invention; and

FIG. 2 is a circuit diagram of a second embodiment of a regulating circuit according to the invention, with switched capacitors.

### DETAILED DESCRIPTION OF THE PREFERRED EMBODIMENTS

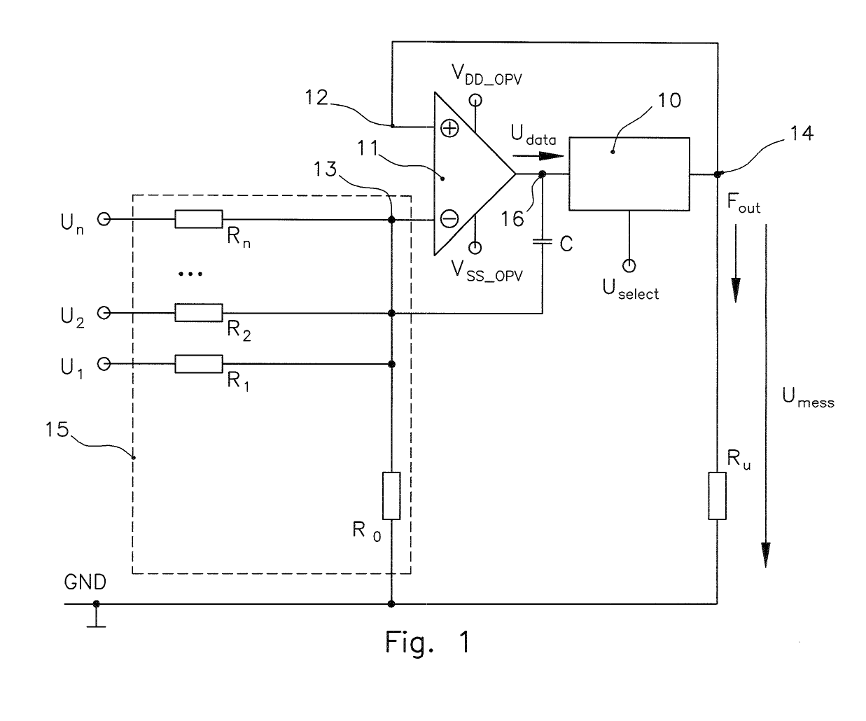

FIG. 1 shows a first possible embodiment of a regulating circuit according to the invention for a pixel circuit 10 with a light-emitting diode; this pixel circuit 10 may for example be the circuit with three thin-film transistors disclosed in DE 10254511 B4. The function of the regulating circuit according to the invention is to compensate the fluctuations in diode current due to manufacturing discrepancies in the driving thin-film transistors, in order that a brightness of maximum homogeneity is obtained across the entire display screen. To that end, the circuit has an operational amplifier 11 to the first input 12 of which a measuring signal is applied which corresponds to the current flowing through the driver transistor of the LED. The input 12 is therefore connected to the output 14 of the pixel circuit 10. The output current Iₒᵤₜ of the pixel circuit 10 is converted by a resistor Rᵤ into a voltage signal Uₘₑₛₛ.

A network 15 of passive components is arranged at the second input 13 of the operational amplifier 11; in the example shown in FIG. 1, these passive components are resistors R₀-Rₙ. The network 15 has n inputs to which a digital reference input signal e.g. in the form of binary-weighted voltage values U₁-Uₙ can be applied. By means of the network 15 the digital data word at the input 13 of the operational amplifier 11 is converted into an analogue voltage signal which is compared in the operational amplifier 11 with the measuring voltage signal Uₘₑₛₛ at the input 12. Any difference in the voltage signals at the inputs 12 and 13 is compensated by the operational amplifier 11 by the generation of a corresponding output signal Uₒᵤₜ at the output 16 of the operational amplifier 11, which also serves as the input of the pixel circuit 10. The voltage at the input 13 of the operational amplifier 11 depends not only on the digital data word at the inputs U₁-Uₙ of the network 15 but also on the state of charge of a capacitor C arranged between the input 13 and the output 16 of the operational amplifier 11. The capacitor C reduces the overshoot at the output 16 of the operational amplifier 11. By virtue of the capacitor C the whole regulating circuit acquires an approximately integrating characteristic which reduces the overshoot. The output signal Uₒᵤₜ of the operational amplifier 11 passes to the data line of the pixel circuit 10 and thus regulates the current flow through the driver transistor as desired.

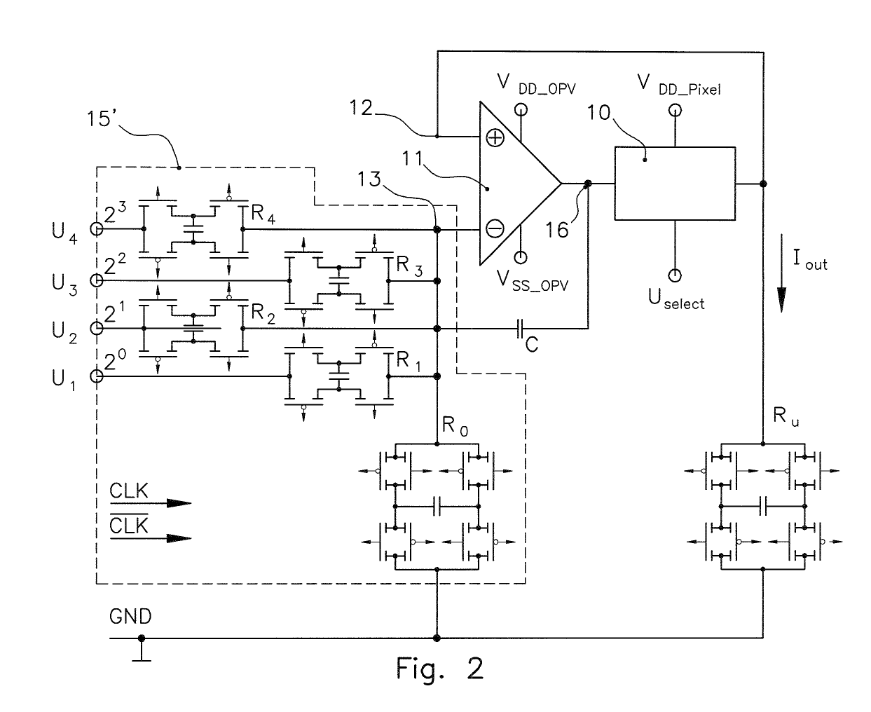

The embodiment of the circuit according to the invention shown in FIG. 2 corresponds to the embodiment shown in FIG. 1 except for the configuration of the network of passive components 15′, which is now realized by switched capacitors. To the four inputs U₁-U₄ of the network 15′, binary-weighted voltage values are applied as a digitally encoded reference voltage input signal which is converted by the network 15′ into an analogue voltage signal at the input 13 of the operational amplifier 11.

It will be understood that each of the elements described above, or two or more together, may also find a useful application in other types of constructions differing from the types described above.

While the invention has been illustrated and described as embodied in a regulating circuit, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A regulating circuit for driving a display screen pixel having a light-emitting diode, comprising:
at least one operational amplifier (11) having a first input (12), a second input (13), and an output (16), wherein a measuring signal (Uₘₑₛₛ) dependent on the flow of current through a driver transistor of the light-emitting diode is applicable to the first input (12) of said at least one operational amplifier; and
a network (15, 15′) consisting of active and/or passive components and at least one capacitor (C), wherein said network (15, 15′) is connected to the second input (13), wherein the network (15, 15′) has a plurality of inputs (U₁-Uₙ), wherein a digital reference input signal is applicable to the plurality of inputs (U₁-Uₙ), and wherein the output (16) of the operational amplifier (11) is connected to a data line of the pixel.

2. The regulating circuit according to claim 1, wherein the at least one capacitor (C) is arranged between the second input (13) and the output (16) of the operational amplifier (11).

3. The regulating circuit according to claim 1, wherein a digital voltage signal is applicable to the inputs (U₁-Uₙ) of the network (15, 15′), and wherein said digital voltage signal is binary-weighted by the network (15, 15′).

4. The regulating circuit according to claim 1, wherein the measuring signal (Uₘₑₛₛ) is generated by current-voltage conversion from a current signal (Iₒᵤₜ) of the driver transistor of the light-emitting diode.

5. The regulating circuit according to claim 4, wherein the current-voltage converter is a resistor (Rᵤ).

6. The regulating circuit according to claim 1, wherein the network (15) comprises resistors.

7. The regulating circuit according to claim 1, wherein the network (15′) comprises switched capacitors and/or the current-voltage converter is a switched capacitor.

8. The regulating circuit according to claim 1, wherein the regulating circuit comprises thin-film transistors based on a polycrystalline semiconductor.

9. The regulating circuit according to claim 8, wherein the operational amplifier comprises thin-film transistors of large dimensions.

10. The regulating circuit according to claim 1, wherein the regulating circuit is integrated together with the pixels of the display screen on the same substrate.

11. The regulating circuit according to claim 1, wherein the regulating circuit is integrated together with other circuit elements required for a column driver of the display screen on a semiconductor chip or substrate.

12. The regulating circuit according to claim 11, wherein the other circuit elements are a column selection register and a data bus.
